(19) United States
(12) Patent Application Publication
(10) Pub. No.: US 2008/0087350 A1
(43) Pub. Date: Apr. 17, 2008

(54) REFRIGERANT-TRANSPORTING HOSE

(75) Inventors: Yuji Takagi, Komaki-shi (JP); Ayumu Ikemoto, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/871,530

(22) Filed: Oct. 12, 2007

(30) Foreign Application Priority Data
Oct. 12, 2006 (JP) 2006-279135
Oct. 12, 2006 (JP) 2006-279136

(51) Int. Cl. F16L 11/04

(52) U.S. Cl. 138/137; 138/141

(57) ABSTRACT

A refrigerant-transporting hose includes a low-permeability layer and a rubber outer layer disposed on the outer peripheral surface of the low-permeability layer. The low-permeability layer is formed from a resin film made of a polyvinyl alcohol with a saponification degree of 90% or more. The resin film has a thickness of 5 to 100μ.

### BACKGROUND OF THE INVENTION

1. Field of the Invention

The present invention relates to refrigerant-transporting hoses such as air conditioner hoses. The present invention particularly relates to a refrigerant-transporting hose which is used to transport a refrigerant (liquid or gas) such as carbon dioxide (CO₂), a chlorofluorocarbon (freon), a chlorofluorocarbon alternative, or propane and which is used as a plumbing hose used in an automobile engine compartment.

2. Description of the Related Art

In general, refrigerant-transporting hoses such as plumbing hoses used in automobile engine compartments are made of rubber because of its attachability, vibration suppression ability, and flexibility. For example, the following hose has been proposed; a hose including a tubular rubber inner layer for transporting a refrigerant, a reinforcing layer disposed on the outer peripheral surface of the inner layer, and a rubber outer layer disposed on the outer peripheral surface of the reinforcing layer (see Japanese unexamined Patent Application Publication No. 7-68659).

Furthermore, the following hoses have been proposed: a hose including an innermost layer which is made of a polyamide-based resin (PA) such that the permeation of a refrigerant, such as a chlorofluorocarbon (freon) or a chlorofluorocarbon alternative (R134a or the like) is prevented (the barrier function against the refrigerant is enhanced) and a hose including a metal foil or a metal laminate formed by vapor deposition (see Japanese Unexamined Patent Application Publication No. 2001-241572).

Chlorofluorocarbons (freons) that were conventionally used as refrigerants for air conditioners for automobiles have been already prohibited from being used because the chlorofluorocarbons destroy the ozone layer in the stratosphere. The amount of emission of chlorofluorocarbon alternatives such as R134a is planned to be reduced. In view of the foregoing circumstances, carbon dioxide (CO₂) refrigerants (liquids or gases) and chemical refrigerants that are environmentally friendly will probably become mainstream.

However, the carbon dioxide refrigerants have higher permeability as compared to conventional refrigerants such as R134a and therefore permeate through polyamide-6 (PA6)-based barrier layers that have high reliability with respect to such conventional refrigerants. Hence, the use of conventional refrigerant-transporting hoses to transport the carbon dioxide refrigerants leads to a reduction in cooling capacity. The following structure has been investigated: a multilayer structure including a PA6 layer and a high-barrier layer disposed on the outer peripheral surface of the PA6 layer. In the multilayer structure, a carbon dioxide refrigerant permeates through the PA6 layer to accumulate between these two layers. The carbon dioxide refrigerant accumulating therebetween expands in a degassing (decompression) operation during the maintenance of an air conditioner. This may cause delamination.

On the other hand, in a hose including a laminate such as a metal foil, the laminate is removed from the hose during long-term use. This causes a problem in that the impermeability of the hose to a refrigerant gas is destabilized.

### SUMMARY OF THE INVENTION

The present invention has been made in view of the foregoing circumstances. It is an object of the present invention to provide a refrigerant-transporting hose which is highly flexible and which has excellent impermeability to refrigerants.

In order to achieve the above object, a refrigerant-transporting hose according to the present invention includes a low-permeability layer and a rubber outer layer disposed on the outer peripheral surface of the low-permeability layer. The low-permeability layer is formed from a resin film made of a polyvinyl alcohol with a saponification degree of 90% or more. The resin film has a thickness of 5 to 100>m.

In order to solve the above problems, the inventors have made intensive investigation. In the investigation, the inventors have found that a hose including an inner coating layer made of a polyvinyl alcohol with a saponification degree of 90% or more has excellent impermeability to refrigerants (particularly a carbon dioxide refrigerant) although the coating layer has a small thickness. Furthermore, the inventors have found that the presence of a rubber outer layer located on the outer peripheral surface of the coating layer (PVOH layer) enhances the vibration absorbability of the hose and/or the resistance of the hose to mechanical impact applied from outside and the impermeability and flexibility of the hose can be well-balanced by setting the thickness of the coating layer within a specific range. This configuration allows the hose to exhibit desired performance. This has led to the present invention.

Since the refrigerant-transporting hose of the present invention includes the low-permeability layer and the rubber outer layer disposed on the outer peripheral surface of the low-permeability layer and the low-permeability layer is formed from the resin film, which is made of the polyvinyl alcohol with a saponification degree of 90% or more and has a thickness of 5 to 100 μm, the refrigerant-transporting hose has excellent impermeability particularly to a carbon dioxide refrigerant. This prevents the cooling capacity of air conditioners from being reduced by the permeation of refrigerants. Furthermore, since the refrigerant-transporting hose of the present invention has excellent flexibility, the refrigerant-transporting hose can be readily plumbed and can be used as a plumbing hose used in an automobile engine compartment that is violently shaken.

In particular, when the rubber outer layer, which is disposed on the outer peripheral surface of the low-permeability layer, is made of butyl rubber, the refrigerant-transporting hose has excellent impermeability to refrigerants and also has high resistance to external water.

When an innermost layer made of specific rubber such as butyl-based rubber or ethylene-propylene-based rubber is disposed on the inner peripheral surface of the low-permeability layer, the presence of the innermost layer enhances the resistance of the refrigerant-transporting hose to refrigerator oils contained in refrigerants for air conditioners and also enhances the attachability of the refrigerant-transporting hose. Also, a CO₂ refrigerant is prevented from accumulating between the innermost layer and the low-permeability layer. This prevents the innermost layer and the low-permeability layer from being delaminated from each other. Since the refrigerant-transporting hose having such a configuration has excellent flexibility, the refrigerant-transporting hose can be readily plumbed and can be used as a plumbing hose used in an automobile engine compartment that is violently shaken.

### BRIEF DESCRIPTION OF THE DRAWINGS

FIG. 1 is a sectional view of a refrigerant-transporting hose according to an embodiment of the present invention; and

FIG. 2 is a sectional view of a refrigerant-transporting hose according to another embodiment of the present invention.

### DESCRIPTION OF THE PREFERRED EMBODIMENTS

Embodiments of the present invention will now be described in detail.

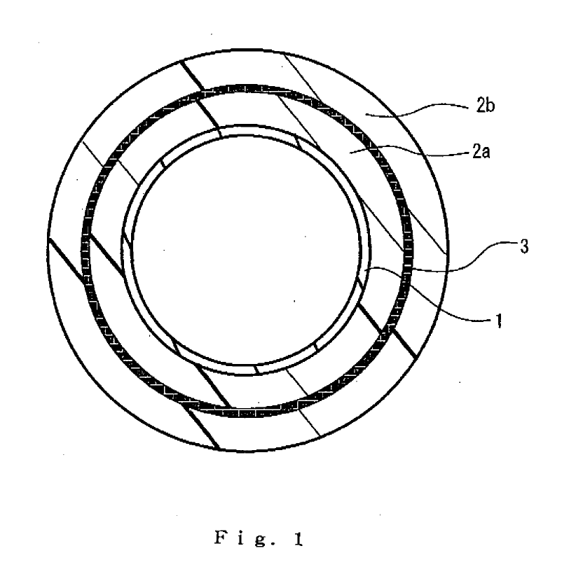

A refrigerant-transporting hose according to the present invention includes, for example, a low-permeability layer 1 and a rubber outer layer (an inside rubber outer sublayer 2a and an outside rubber outer sublayer 2b) disposed on the outer peripheral surface of the low-permeability layer 1 as shown in FIG. 1. The low-permeability layer 1 is formed from a resin film made of a polyvinyl alcohol with a saponification degree of 90% or more and has a thickness of 5 to 100 μm. With reference to FIG. 1, the rubber outer layer has a two-layer structure consisting of the inside rubber outer sublayer 2a and the outside rubber outer sublayer 2b. The structure of the rubber outer layer is not particularly limited and the rubber outer layer may have a single-layer structure or a three or more layer structure. The refrigerant-transporting hose may further include a reinforcing layer 3 as shown in FIG. 1.

The polyvinyl alcohol (PVOH), which has a saponification degree of 90% or more, is a material for forming the low-permeability layer 1 as described above. This is because when the polyvinyl alcohol has a saponification degree of less than 90%, the impermeability to a carbon dioxide refrigerant cannot be maintained at a desired level. The saponification degree of the polyvinyl alcohol can be determined in such a manner that m and n in the following chemical formula (1) representing the polyvinyl alcohol are applied to the following mathematical formula (a):

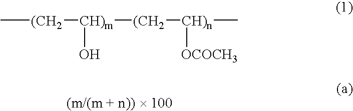

The polyvinyl alcohol, which is the low-permeability layer 1-forming material, is used in the form of a coating solution prepared by dissolving the polyvinyl alcohol in water or alcohol (methanol, ethanol, isopropyl alcohol, or the like). In particular, water (hot water heated to about 90° C. to 95° C.) is preferably used in view of the ability to dissolve the low-permeability layer 1-forming material. The coating solution prepared as described above preferably has a viscosity of 10 to 1,000,000 mPa·s at 25° C. in view of coating properties (wettability and workability) and the like.

A material for forming the rubber outer layer (the inside and outside rubber outer sublayers 2a and 2b) , which is disposed on the outer peripheral surface of the low-permeability layer 1, is not particularly limited. The following composition may be used to form the rubber outer layer: a composition prepared by compounding a vulcanizing agent and/or carbon black with a rubber material such as butyl rubber (IIR), halogenated butyl rubber such as chlorinated butyl rubber (Cl-IIR) or brominated butyl rubber (Br-IIR), acrylonitrile-butadiene rubber (NBR), chloroprene rubber (CR), ethylene-propylene-diene rubber (EPDM), ethylene-propylene rubber (EPM), fluorine rubber (FKM), epichlorohydrin rubber (ECO), acrylic rubber, silicone rubber, chlorinated polyethylene rubber (CPE), or urethane rubber. In particular, butyl rubber (IIR) is preferably used because the rubber outer layer has high impermeability to refrigerants and high water resistance. When the rubber outer layer has such a two-layer structure as shown in FIG. 1 or a three or more layer structure, the outermost layer thereof is preferably made of EPDM in view of weather resistance. The rubber outer layer-forming material may contain carbon black, an anti-aging agent, a vulcanizing agent, a vulcanization accelerator, a processing aid, a white filler, a plasticizer, a softening agent, an acid acceptor, a colorant, and/or an anti-scorching agent as required.

With reference to FIG. 1, the rubber outer layer includes the two sublayers: the inside and outside rubber outer sublayers 2a and 2b. When the rubber outer layer includes two or more sublayers, materials for forming these sublayers may be the same or different from each other. As required, the reinforcing layer 3 may be formed as shown in FIG. 1. The reinforcing layer 3 is preferably disposed between the inside and outside rubber outer sublayers 2a and 2b as shown in this figure because the reinforcing layer 3 has a sufficient function (a hose pressure-resistant function). The reinforcing layer 3 can be formed by spirally weaving, knitting, or braiding reinforcing cords made of, for example, polyethylene terephthalate (PET), polyethylene naphthalate (PEN), aramid, polyamide (nylon), vinylon, rayon, or metal wires.

The refrigerant-transporting hose, shown in FIG. 1, according to the present invention can be manufactured in, for example, a manner described below. The rubber outer layer-forming material is extruded into a hose, which is shaped into the tubular rubber outer layer. The reinforcing layer 3 is formed as required (with reference to FIG. 1, the inside rubber outer sublayer 2a is formed, the reinforcing layer 3 is formed on the outer peripheral surface of the inside rubber outer sublayer 2a, and the outside rubber outer sublayer 2b is then formed on the outer peripheral surface of the reinforcing layer 3). A mandrel may be used to extrude the rubber outer layer-forming material. The low-permeability layer (resin film) 1-forming material (the coating solution) is prepared and then applied onto the inner peripheral surface of the hose obtained as described above. A process for coating the inner peripheral surface thereof is not particularly limited. Useful examples of the coating process include conventional processes such as a dipping process a spraying process, and a flow-casting process. The coated inner peripheral surface is dried, whereby the low-permeability layer (resin film) 1 is formed so as to have a specific thickness. The refrigerant-transporting hose having an intended layer structure can be manufactured as described above.

The refrigerant-transporting hose, manufactured as described above, according to the present invention preferably has an inner diameter of 5 to 40 mm.

According to the present invention, the low-permeability layer 1 needs to have a thickness of 5 to 100 μm. When the thickness of the low-permeability layer 1 is less than 5 μm, the impermeability to refrigerants is insufficient. In contrast, when the thickness of the low-permeability layer 1 exceeds 100 μm, the resin film is inflexible and therefore the refrigerant-transporting hose is poor in flexibility. This can cause cracks in the refrigerant-transporting hose.

The thickness of the rubber outer layer, which is disposed on the outer peripheral surface of the low-permeability layer 1, is not particularly limited. When the rubber outer layer includes the inside and outside rubber outer sublayers 2a and 2b as shown in FIG. 1, the inside rubber outer sublayer 2a preferably has a thickness of 0.5 to 5.0 mm and the outside rubber outer sublayer 2b preferably has a thickness of 0.5 to 2.0 mm.

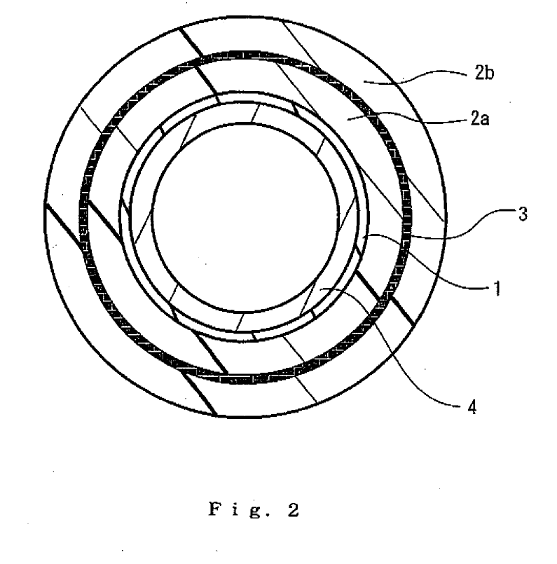

The refrigerant-transporting hose according to the present invention has the layer structure shown in FIG. 1 and may further include, for example, an innermost layer 4 as shown in FIG. 2. The innermost layer 4 is disposed on the inner peripheral surface of the low-permeability layer 1 and is made of butyl-based rubber or ethylene-propylene-based rubber. This configuration provides high resistance to refrigerator oils contained in refrigerants for air conditioners and also provides good hose attachability in addition to the performance of the refrigerant-transporting hose shown in FIG. 1. Also, a CO₂ refrigerant is prevented from accumulating between the innermost layer 4 and the low-permeability layer 1. This prevents the innermost layer 4 and the low-permeability layer 1 from being delaminated from each other. The refrigerant-transporting hose having this configuration is highly flexible and therefore can be readily plumbed. The refrigerant-transporting hose can be used as a plumbing hose used in an automobile engine compartment that is violently shaken.

Examples of a material for forming the innermost layer 4 include the butyl-based rubber and ethylene-propylene-based rubber described above. Examples of the butyl-based rubber include butyl rubber (IIR), chlorinated butyl rubber (Cl-IIR), and brominated butyl rubber (Br-IIR). Examples of the ethylene-propylene-based rubber include ethylene-propylene-diene rubber (EPDM) and ethylene-propylene rubber (EPM). These rubbers may be used alone or in combination.

The innermost layer 4-forming material may contain carbon black, an anti-aging agent, a vulcanizing agent, a vulcanization accelerator, a processing aid, a white filler, a plasticizer, a softening agent, an acid acceptor, a colorant, and/or an anti-scorching agent as required in addition to the above rubber.

The refrigerant-transporting hose shown in FIG. 2 is substantially the same as the hose shown in FIG. 1 except that the refrigerant-transporting hose shown in FIG. 2 includes the innermost layer 4. Therefore, materials for forming layers other than the innermost layer 4 are the same as those for forming the layers of the refrigerant-transporting hose shown in FIG. 1.

The refrigerant-transporting hose, shown in FIG. 2, according to the present invention can be manufactured in, for example, a manner described below. The innermost layer 4-forming material and the low-permeability layer 1-forming material (the coating solution) are separately prepared. The innermost layer 4-forming material is extruded into a hose, which is shaped into the tubular innermost layer 4. In this operation, a mandrel may be used. The outer peripheral surface of the innermost layer 4 is coated with the coating solution for forming the low-permeability layer 1. A process for coating the outer peripheral surface thereof is not particularly limited. Useful examples of the coating process include conventional processes such as a dipping process, a spraying process, a roll-coating process, and a brush coating process. The coated outer peripheral surface is dried, whereby the low-permeability layer (resin film) 1 is formed so as to have a specific thickness. After the low-permeability layer 1 is formed, the rubber outer layer is formed on the outer peripheral surface of the low-permeability layer 1 by extruding. The reinforcing layer 3 is formed as required (with reference to FIG. 2, the inside rubber outer sublayer 2a is formed, the reinforcing layer 3 is formed on the outer peripheral surface of the inside rubber outer sublayer 2a, and the outside rubber outer sublayer 2b is then formed on the outer peripheral surface of the reinforcing layer 3), whereby the refrigerant-transporting hose having an intended layer structure can be manufactured.

In the refrigerant-transporting hose shown in FIG. 2, before the low-permeability layer 1 is formed, the outer peripheral surface of the innermost layer 4 may be subjected to etching treatment, such as ultraviolet ray irradiation treatment, plasma treatment, or corona discharge treatments, corresponding to adhesive base treatment. In particular, the outer peripheral surface of the innermost layer 4 is preferably roughened by plasma treatment because the adhesiveness (interlayer adhesion) to coatings is improved. The low-permeability layer 1 is formed on the rough outer peripheral surface.

In the refrigerant-transporting hose shown in FIG. 2, before the low-permeability layer 1 is formed, an adhesive layer may be formed on the outer peripheral surface of the innermost layer 4. A material for forming the adhesive layer is not particularly limited. Examples of the adhesive layer-forming material include a rubber-based adhesive, a urethane-based adhesive, a polyester-based adhesive, an isocyanate-based adhesive, and an epoxy-based adhesive. These adhesives may be used alone or in combination. In particular, the rubber-based adhesive is preferably used because the rubber-based adhesive is effective in ensuring the interlayer adhesion between the innermost layer 4 and the low-permeability-layer 1.

The refrigerant-transporting hose shown in FIG. 2, as well as that shown in FIG. 1, preferably has an inner diameter of 5 to 40 mm. The innermost layer 4 preferably has a thickness of 0.5 to 2.0 mm.

In the refrigerant-transporting hose shown in FIG. 2, as well as that shown in FIG. 1, the low-permeability layer 1 needs to have a thickness of 5 to 100 μm. The rubber outer layer, which is disposed on the outer peripheral surface of the low-permeability layer 1, has the same thickness as that of the rubber outer layer of the refrigerant-transporting hose shown in FIG. 1.

The refrigerant-transporting hose, shown in FIG. 1 or 2, according to the present invention is suitable for transporting refrigerants, such as carbon dioxide, chlorofluorocarbons, chlorofluorocarbon alternatives, and propane, for air conditioners or radiators. In particular, the refrigerant-transporting hose is suitable for use in transporting a carbon dioxide refrigerant. The refrigerant-transporting hose is suitable for use in not only cars but also transport machinery (aircraft; industrial transport vehicles, such as forklift trucks, shovel loaders, and cranes; and rail vehicles).

### EXAMPLES

Examples and comparative examples will now be described. The present invention is not limited to the examples and the comparative examples.

### Example 1

Butyl rubber was extruded around a mandrel (an outer diameter of 8.0 nm) made of TPX (a synthetic resin) in a hose shape, whereby a tubular hose body (an inside rubber outer sublayer with a thickness of 1.6 mm) was formed. A reinforcing layer was formed on the outer peripheral surface of the hose body by braiding aramid cords. An outside rubber outer sublayer (a thickness of 1.0 mm) was formed on the outer peripheral surface of the reinforcing layer by extruding EPDM. After being vulcanized, the laminate was removed from the mandrel. The following solution was flow-cast on the inner peripheral surface of the hose body (the inner peripheral surface of the inside rubber outer sublayer) through an end opening of the hose body; a coating solution (a viscosity of 500 mPa·s at 25° C.) prepared by dissolving a polyvinyl alcohol (PVOH) (Gohsenol N-300, produced by The Nippon Synthetic Chemical Industry Co., Ltd.) having a saponification degree of 0.99% in 90° C. hot water. The resulting laminate was placed in a drying oven and then dried, whereby a low-permeability layer (a thickness of 10 μm) due to dipping was formed. The elongated molding prepared as described above was cut, whereby an intended refrigerant-transporting hose was manufactured (see FIG. 1).

### Example 2

An intended refrigerant-transporting hose was prepared in substantially the same manner as that described in Example 1 except that a low-permeability layer (a PVOH layer) of the refrigerant-transporting hose had a thickness of 100 μm.

### Example 3

An intended refrigerant-transporting hose was prepared in substantially the same manner as that described in Example 1 except that a low-permeability layer (a PVOH layer) of the refrigerant-transporting hose had a thickness of 5 μm.

### Example 4

An intended refrigerant-transporting hose was prepared in substantially the same manner as that described in Example 1 except that a PVOH (Gohsenol AH-17, produced by The Nippon Synthetic Chemical Industry Co., Ltd.) with a saponification degree of 90% was used to form a low-permeability layer (a PVOH layer) of the refrigerant-transporting hose and the low-permeability layer (the PVOH layer) had a thickness of 5 μm.

### Comparative Example 1

An intended refrigerant-transporting hose was prepared in substantially the same manner as that described in Example 1 except that a PVOH (Gohsenol GH-17, produced by The Nippon Synthetic Chemical Industry Co., Ltd.) with a saponification degree of 86% was used to form a low-permeability layer (a PVOH layer) of the refrigerant-transporting hose and the low-permeability layer (the PVOH layer) had a thickness of 5 μm.

### Comparative Example 2

An intended refrigerant-transporting hose was prepared in substantially the same manner as that described in Example 1 except that a low-permeability layer (a PVOH layer) of the refrigerant-transporting hose had a thickness of 101 μm.

### Comparative Example 3

An intended refrigerant-transporting hose was prepared in substantially the same manner as that described in Example 1 except that a low-permeability layer (a PVOH layer) of the refrigerant-transporting hose had a thickness of 2 μm.

### Comparative Example 4

An intended refrigerant-transporting hose was prepared in substantially the same manner as that described in Example 1 except that polyamide (PA6) was used to form a low-permeability layer of the refrigerant-transporting hose instead of the PVOH and the low-permeability layer had a thickness of 100 μm.

The refrigerant-transporting hoses of Examples 1 to 4 and Comparative Examples 1 to 4 were evaluated for CO₂ permeability, film formability, and cracking resistance according to standards below. The evaluation results were summarized in Table 1 shown below.

CO₂ Permeability

Both end openings of each refrigerant-transporting hose were plugged in such a state that carbon dioxide (CO₂) was sealed in the refrigerant-transporting hose at low temperature (−35° C. or lower). The resulting refrigerant-transporting hose was placed in a 90° C. oven. The reduction in the amount of carbon dioxide in the refrigerant-transporting hose was plotted against time, whereby a curve was obtained. The amount of CO₂ permeating through a unit area of the refrigerant-transporting hose per day (the CO₂ permeation coefficient in mg·mm/cm²·day) was calculated from the slope of the curve. The CO₂ permeation coefficient of the refrigerant-transporting hose of each Example or Comparative Example was transformed into an index on the basis that the CO₂ permeation coefficient of the refrigerant-transporting hose of Comparative Example 4 was 100, the refrigerant-transporting hose of Comparative Example 4 including no PVOH layer. In the evaluation for CO₂ permeability, the refrigerant-transporting hoses having an index of 50 or less were evaluated to be superior (o) and the refrigerant-transporting hoses having an index of greater than 50 were evaluated to be inferior (x).

Film Formability

After the application of aqueous PVOH solutions, the solutions were visually evaluated for film formability. Coatings of the solutions that had no eye holes (including pinholes) or no blisters were evaluated to be superior (o) and coatings of the solutions that had eye holes or blisters were evaluated to be inferior (x).

Cracking Resistance

The refrigerant-transporting hose of each Example or Comparative Example was bent to 90 degrees and then cut into half. The refrigerant-transporting hoses including the low-permeability layers (PVOH layers) having defects such as cracks and delaminated portions were evaluated to be inferior (x). The refrigerant-transporting hoses including the low-permeability layers having no defects were evaluated to be superior (o).

TABLE 1

| | | Examples | | | | Comparative Examples | | | |
|---|---|---|---|---|---|---|---|---|---|
| | | 1 | 2 | 3 | 4 | 1 | 2 | 3 | 4 |
| CO₂ | Index | 9 | 1 | 15 | 25 | 65 | 1 | 90 | 100 |
| permeability | Evaluation | ∘ | ∘ | ∘ | ∘ | x | ∘ | x | x |

| | | | | | | | | |
|---|---|---|---|---|---|---|---|---|
| Film formability | ∘ | ∘ | ∘ | ∘ | ∘ | ∘ | x | — |
| Cracking resistance | ∘ | ∘ | ∘ | ∘ | ∘ | x | ∘ | — |

The above results show that the refrigerant-transporting hoses of Examples 1 to 4 have higher flexibility, less cracks, and lower CO₂ permeability as compared to the refrigerant-transporting hoses of Comparative Examples 1 to 4.

### Example 5

EPDM (produced by Tokai Rubber Industries, Ltd.) was extruded around a mandrel (an outer diameter of 8.0 mm) made of TPX (a synthetic resin) in a hose shape, whereby a tubular innermost layer (a thickness of 1.2 mm) was formed. The outer peripheral surface of the innermost layer was plasma-treated, whereby the outer peripheral surface of the innermost layer was roughened. An adhesive layer (a thickness of 5 μm) made of a rubber-based adhesive was formed on the roughened outer peripheral surface of the innermost layer and then coated with the following solution by a dipping process: a coating solution (a viscosity of 500 mPa·s at 25° C.) prepared by dissolving a polyvinyl alcohol (PVOH) (Gohsenol N-300, produced by The Nippon Synthetic Chemical Industry Co., Ltd.) having a saponification degree of 99% in 90° C. hot water. The laminate was placed in a drying oven and then dried, whereby a coating layer (a low-permeability layer with a thickness of 10 μm) due to dipping was formed. An inside rubber outer sublayer (a thickness of 1.6 mm) was formed on the outer peripheral surface of the coating layer by extruding butyl rubber. A reinforcing layer was formed on the outer peripheral surface of the inside rubber outer sublayer by braiding aramid cords. An outside rubber outer sublayer (a thickness of 1.0 mm) was formed on the outer peripheral surface of the reinforcing layer by extruding EPDM. After being vulcanized, the laminate was removed from the mandrel, whereby an elongated molding was prepared. The elongated molding was cut, whereby an intended refrigerant-transporting hose was manufactured (see FIG. 2).

### Example 6

An intended refrigerant-transporting hose was prepared in substantially the same manner as that described in Example 5 except that a coating layer (a PVOH layer) of the refrigerant-transporting hose had a thickness of 100 μm.

### Example 7

An intended refrigerant-transporting hose was prepared in substantially the same manner as that described in Example 5 except that a coating layer (a PVOH layer) of the refrigerant-transporting hose had a thickness of 5 μm.

### Example 8

An intended refrigerant-transporting hose was prepared in substantially the same manner as that described in Example 5 except that a PVOH (Gohsenol AH-17, produced by The Nippon Synthetic Chemical Industry Co., Ltd.) with a saponification degree of 90% was used to form a coating layer (a PVOH layer) of the refrigerant-transporting hose and the coating layer (the PVOH layer) had a thickness of 5 μm.

### Comparative Example 5

An intended refrigerant-transporting hose was prepared in substantially the same manner as that described in Example 5 except that a PVOH (Gohsenol GH-17, produced by The Nippon Synthetic Chemical Industry Co., Ltd.) with a saponification degree of 86% was used to form a coating layer (a PVOH layer) of the refrigerant-transporting hose and the coating layer (the PVOH layer) had a thickness of 5 μm.

### Comparative Example 6

An intended refrigerant-transporting hose was prepared in substantially the same manner as that described in Example 5 except that a coating layer (a PVOH layer) of the refrigerant-transporting hose had a thickness of 101 μm.

### Comparative Example 7

An intended refrigerant-transporting hose was prepared in substantially the same manner as that described in Example 5 except that a coating layer (a PVOH layer) of the refrigerant-transporting hose had a thickness of 2 μm.

### Comparative Example 8

An intended refrigerant-transporting hose was prepared in substantially the same manner as that described in Example 5 except that polyamide (PA6) was used to form a coating layer of the refrigerant-transporting hose instead of the PVOH and the coating layer had a thickness of 100 μm.

The refrigerant-transporting hoses of Examples 5 to 8 and Comparative Examples 5 to 8 were evaluated for CO₂ permeability, film formability, and cracking resistance according to standards below. The evaluation results were summarized in Table 2 shown below.

CO₂ Permeability

Both end openings of each refrigerant-transporting hose were plugged in such a state that carbon dioxide (CO₂) was sealed in the refrigerant-transporting hose at low temperature (−35° C. or lower). The resulting refrigerant-transporting hose was placed in a 90° C. oven. The reduction in the amount of carbon dioxide in the refrigerant-transporting hose was plotted against time, whereby a curve was obtained. The amount of CO₂ permeating through a unit area of the refrigerant-transporting hose per day (the CO₂ permeation coefficient in mg-mm/cm² day) was calculated from the slope of the curve. The CO₂ permeation coefficient of the refrigerant-transporting hose of each Example or Comparative Example was transformed into an index on the basis that the CO₂ permeation coefficient of the refrigerant-transporting hose of Comparative Example 4 was 100, the refrigerant-transporting hose of Comparative Example 4 including no PVOH layer. In the evaluation for CO₂ permeability, the refrigerant-transporting hoses having an index of 50 or less were evaluated to be superior (o) and the refrigerant-transporting hoses having an index of greater than 50 were evaluated to be inferior (x).

Film Formability

After the application of aqueous PVOH solutions, the solutions were visually evaluated for film formability. Coatings of the solutions that had no eye holes (including pinholes) or no blisters were evaluated to be superior (o) and coatings of the solutions that had eye holes or blisters were evaluated to be inferior (x).

Cracking Resistance

In the examples and the comparative examples, tubes (tubes including innermost layers and coating layers which were formed on the outer peripheral surfaces of the innermost layers and then dried) including no inside rubber outer sublayers, no reinforcing layers, or no outside rubber outer sublayers were evaluated for cracking resistance. That is, each refrigerant-transporting hose was bent to 90 degrees. The refrigerant-transporting hoses including the coating layers (PVOH layers) having defects such as cracks and delaminated portions were evaluated to be inferior (x). The refrigerant-transporting hoses including the coating layers having no defects were evaluated to be superior (o).

TABLE 2

| | | Examples | | | | Comparative Examples | | | |
|---|---|---|---|---|---|---|---|---|---|
| | | 5 | 6 | 7 | 8 | 5 | 6 | 7 | 8 |
| CO₂ | Index | 9 | 1 | 15 | 25 | 65 | 1 | 90 | 100 |
| permeability | Evaluation | ∘ | ∘ | ∘ | ∘ | x | ∘ | x | x |

| | | | | | | | | |
|---|---|---|---|---|---|---|---|---|
| Film formability | ∘ | ∘ | ∘ | ∘ | ∘ | ∘ | x | — |
| Cracking resistance | ∘ | ∘ | ∘ | ∘ | ∘ | x | ∘ | — |

The above results show that the refrigerant-transporting hoses of Examples 5 to 8 have higher flexibility, less cracks, and lower CO₂ permeability as compared to the refrigerant-transporting hoses of Comparative Examples 5 to 8.

Experiments have confirmed that refrigerant-transporting hoses, similar to the refrigerant-transporting hoses of Examples 5 to 8 that include the innermost layers made of EPDM, including innermost layers made of butyl-based rubber (IIR, Cl-IIR, or Br-IIR) or EPM have excellent performance.

### INDUSTRIAL APPLICABILITY

A refrigerant-transporting hose according to the present invention is suitable for transporting refrigerants, such as carbon dioxide, chlorofluorocarbons, chlorofluorocarbon alternatives, and propane, for air conditioners or radiators.

What is claimed is:

1. A refrigerant-transporting hose comprising:
a low-permeability layer; and
a rubber outer layer disposed on an outer peripheral surface of the low-permeability layer,
wherein the low-permeability layer is formed from a resin film made of a polyvinyl alcohol with a saponification degree of 90% or more and the resin film has a thickness of 5 to 100 μm.

2. The refrigerant-transporting hose according to claim 1, wherein the rubber outer layer is made of butyl rubber.

3. The refrigerant-transporting hose according to claim 1, further comprising an innermost layer which is made of at least one of butyl-based rubber and ethylene-propylene-based rubber and which is disposed on an inner peripheral surface of the low-permeability layer.

4. The refrigerant-transporting hose according to claim 3, further comprising an adhesive layer disposed between the innermost layer and the low-permeability layer.

5. The refrigerant-transporting hose according to claim 4, wherein the adhesive layer is made of a rubber-based adhesive.

6. The refrigerant-transporting hose according to claim 3, wherein the outer peripheral surface of the innermost layer is roughened by plasma treatment.

7. The refrigerant-transporting hose according to claim 1, further comprising a carbon dioxide (CO₂) refrigerant within a passageway of the hose.
